(19) United States
(12) Patent Application Publication
(10) Pub. No.: US 2022/0258734 A1
(43) Pub. Date: Aug. 18, 2022

(54) RUNNING SUPPORT SYSTEM FOR VEHICLE AND RUNNING SUPPORT METHOD FOR VEHICLE

(71) Applicant: TOYOTA JIDOSHA KABUSHIKI KAISHA, Aichi-ken (JP)

(72) Inventor: Tsutomu MIYAZAKI, Miyoshi-shi (JP)

(21) Appl. No.: 17/563,048

(22) Filed: Dec. 28, 2021

(30) Foreign Application Priority Data
Feb. 12, 2021 (JP) 2021-021277

(51) Int. Cl. B60W 30/14

(52) U.S. Cl. CPC B60W 30/143; B60W 2720/10; B60W 2556/50; B60W 2552/35

(57) ABSTRACT

A running support system executes: a specifying process of specifying a currently-running area from among a plurality of running areas, the currently-running area being a running area where a vehicle is running; an appropriate value setting process of setting a vehicle speed appropriate value that is an appropriate vehicle speed when the vehicle runs in the currently-running area; and a support process of at least either notifying a driver of the vehicle speed appropriate value or decelerating the vehicle in a case where a vehicle speed exceeds the vehicle speed appropriate value. In the appropriate value setting process, in a case where an advancing direction of the vehicle does not accord with a reference advancing direction, a value smaller than a value to be set in a case where the advancing direction accords with the reference advancing direction is set as the vehicle speed appropriate value.

### CROSS-REFERENCE TO RELATED APPLICATION

This application claims priority to Japanese Patent Application No. 2021-021277 filed on Feb. 12, 2021, incorporated herein by reference in its entirety.

### BACKGROUND

### 1. Technical Field

The present disclosure relates to a running support system for a vehicle and a running support method for a vehicle.

### 2. Description of Related Art

Japanese Unexamined Patent Application Publication No. 2016-78730 (JP 2016-78730 A) describes an example of a vehicle speed control in automatic running of a vehicle. That is, in a case where a vehicle is caused to run along a curve, an appropriate vehicle speed that is a vehicle speed appropriate for the vehicle to run along the curve is derived based on the curvature of the curve or a curve running history.

### SUMMARY

The appropriate vehicle speed can vary depending on the advancing direction of the vehicle at the time of running along a curve. Such a problem is not limited to a case where the vehicle runs along a curve and can occur in a case where the vehicle runs along a straight course.

A running support system for a vehicle that is accomplished to solve the above problem is a system for supporting a vehicle operation performed by a driver during vehicle running. The running support system includes an execution device and a storage device. A road where the vehicle runs is stored in the storage device such that the road is divided into a plurality of running areas. Respective reference advancing directions for the running areas are stored in the storage device, the respective reference advancing directions serving as references for an advancing direction of the vehicle when the vehicle runs in the running areas. The execution device is configured to execute processes including: a specifying process of specifying a currently-running area from among the running areas, the currently-running area being a running area where the vehicle is running; an appropriate value setting process of setting a vehicle speed appropriate value that is an appropriate vehicle speed when the vehicle runs in the currently-running area; and a support process of at least either notifying the driver of the vehicle speed appropriate value or decelerating the vehicle in a case where a vehicle speed exceeds the vehicle speed appropriate value. In the appropriate value setting process, in a case where the advancing direction of the vehicle does not accord with the reference advancing direction, the execution device sets, as the vehicle speed appropriate value, a value smaller than a value to be set in a case where the advancing direction of the vehicle accords with the reference advancing direction.

In the above configuration, an area where the vehicle is running is specified as the currently-running area from among the running areas, and a vehicle speed appropriate value for the currently-running area is set. Then, in the support process, the driver is notified of the vehicle speed appropriate value, or the vehicle is decelerated so that the vehicle speed does not exceed the vehicle speed appropriate value.

In the above configuration, in the appropriate value setting process, in a case where the reference advancing direction of the currently-running area does not accord with the advancing direction of the vehicle, a value smaller than a value to be set in a case where the reference advancing direction accords with the advancing direction of the vehicle is set as the vehicle speed appropriate value. That is, the vehicle speed appropriate value is set in consideration of the advancing direction of the vehicle, so that the vehicle speed appropriate value changes when the advancing direction changes.

Accordingly, with the above configuration, the vehicle speed appropriate value can be set to have magnitude in consideration of the advancing direction of the vehicle.

In one aspect of the running support system, in the appropriate value setting process, the execution device may determine whether a deviation amount between the advancing direction of the vehicle and the reference advancing direction increases or not, based on at least either one of a lateral acceleration and a yaw rate of the vehicle. In a case where the execution device determines that the deviation amount increases, the execution device may set, as the vehicle speed appropriate value, a value smaller than a value to be set in a case where the execution device determines that the deviation amount does not increase.

When the driver performs steering, the lateral acceleration and the yaw rate of the vehicle change. Further, at the time when disturbance is input in the vehicle, the lateral acceleration and the yaw rate of the vehicle may also change. When at least either one of the lateral acceleration and the yaw rate changes, the advancing direction of the vehicle may change.

In the above configuration, whether the deviation amount between the advancing direction of the vehicle and the reference advancing direction increases or not is determined based on at least either one of the lateral acceleration and the yaw rate of the vehicle. Then, in a case where the deviation amount is determined to increase, a value smaller than a value to be set in a case where the deviation amount is determined not to increase is set as the vehicle speed appropriate value. That is, the vehicle speed appropriate value can be set in consideration of a change in the advancing direction of the vehicle, the change being predictable based on at least either one of the lateral acceleration and the yaw rate of the vehicle.

In the aspect of the running support system, in the appropriate value setting process, the execution device may determine whether a deviation amount between the advancing direction of the vehicle and the reference advancing direction increases or not, based on a steering angle. In a case where the execution device determines that the deviation amount increases, the execution device may set, as the vehicle speed appropriate value, a value smaller than a value to be set in a case where the execution device determines that the deviation amount does not increase.

When the driver performs steering, the advancing direction of the vehicle changes. In the above configuration, whether the deviation amount between the advancing direction of the vehicle and the reference advancing direction increases or not is determined based on the steering angle. Then, in a case where the deviation amount is determined to increase, a value smaller than a value to be set in a case where the deviation amount is determined not to increase is set as the vehicle speed appropriate value. That is, the vehicle speed appropriate value can be set in consideration of a change in the advancing direction of the vehicle, the change being predictable based on the steering of the driver.

In one aspect of the running support system, the processes to be executed by the execution device may include: a road-surface condition acquisition process of acquiring a road-surface condition in the currently-running area; and a correction process of correcting the vehicle speed appropriate value set in the appropriate value setting process based on the road-surface condition in the currently-running area.

In the above configuration, the vehicle speed appropriate value can be set to have magnitude corresponding to the road-surface condition in the currently-running area.

In one aspect of the running support system, the storage device may include a map in which respective reference vehicle speed appropriate values as references for the vehicle speed appropriate value in respective running areas are stored. In the appropriate value setting process, the execution device may acquire a reference vehicle speed appropriate value corresponding to the currently-running area from the map. In a case where the advancing direction of the vehicle accords with the reference advancing direction, the execution device may set, as the vehicle speed appropriate value, a value corresponding to the reference vehicle speed appropriate value thus acquired.

In the above configuration, the reference vehicle speed appropriate value for the currently-running area is acquired from the map, so that the reference vehicle speed appropriate value corresponding to the currently-running area can be set.

In one aspect of the running support system, the map included in the storage device may include a plurality of maps such that the maps correspond to respective vehicle types. In the appropriate value setting process, the execution device may select a map corresponding to a vehicle type of the vehicle from among the maps included in the storage device. The execution device may acquire the reference vehicle speed appropriate value corresponding to the currently-running area from the map.

Different vehicle types have different vehicle speed appropriate values. In view of this, in the above configuration, respective maps are prepared for different vehicle types. Hereby, a reference vehicle speed appropriate value corresponding to a vehicle type can be set.

In one aspect of the running support system, the execution device may include a first execution device provided outside the vehicle, and a second execution device provided in the vehicle. The second execution device may execute some of the processes, and the first execution device may execute remaining processes of the processes.

In the above configuration, the processes are executed by the first execution device and the second execution device in a divided manner. On this account, in comparison with a case where the processes are executed by one execution device, it is possible to reduce loads to the execution devices.

A running support method for a vehicle that is accomplished to solve the above problem is a method for supporting a vehicle operation performed by a driver during vehicle running. The running support method includes: a specifying process of specifying a currently-running area from among a plurality of running areas set by dividing a road where the vehicle runs, the currently-running area being a running area where the vehicle is running; an appropriate value setting process of setting a vehicle speed appropriate value that is an appropriate vehicle speed when the vehicle runs in the currently-running area specified by the specifying process; and a support process of at least either notifying the driver of the vehicle speed appropriate value set in the appropriate value setting process or decelerating the vehicle in a case where a vehicle speed of the vehicle exceeds the vehicle speed appropriate value. Respective reference advancing directions are set for the running areas, the respective reference advancing directions serving as references for an advancing direction of the vehicle when the vehicle runs in the respective running areas. In the appropriate value setting process, in a case where the advancing direction of the vehicle does not accord with the reference advancing direction, a value smaller than a value to be set in a case where the advancing direction of the vehicle accords with the reference advancing direction is set as the vehicle speed appropriate value.

By executing the above processes, it is possible to achieve effects equivalent to the effects of the running support system.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram illustrating an outline of a running support system according to a first embodiment;

FIG. 2 is a view illustrating a course in a circuit field managed by a server of the running support system;

FIG. 3 is a schematic view illustrating some of whole running areas;

FIG. 4 is a map illustrating respective reference vehicle speed appropriate values of the running areas;

FIG. 5 is a schematic view illustrating a reference advancing direction in the running area and advancing directions of a vehicle;

FIG. 6 is a flowchart to describe a processing routine to be executed by a CPU of the server;

FIG. 7 is a flowchart to describe a processing routine to be executed by a CPU of a vehicle control device in the running support system; and

FIG. 8 is a flowchart to describe a processing routine to be executed by a CPU of a vehicle control device in a running support system according to a second embodiment.

### DETAILED DESCRIPTION OF EMBODIMENTS

### First Embodiment

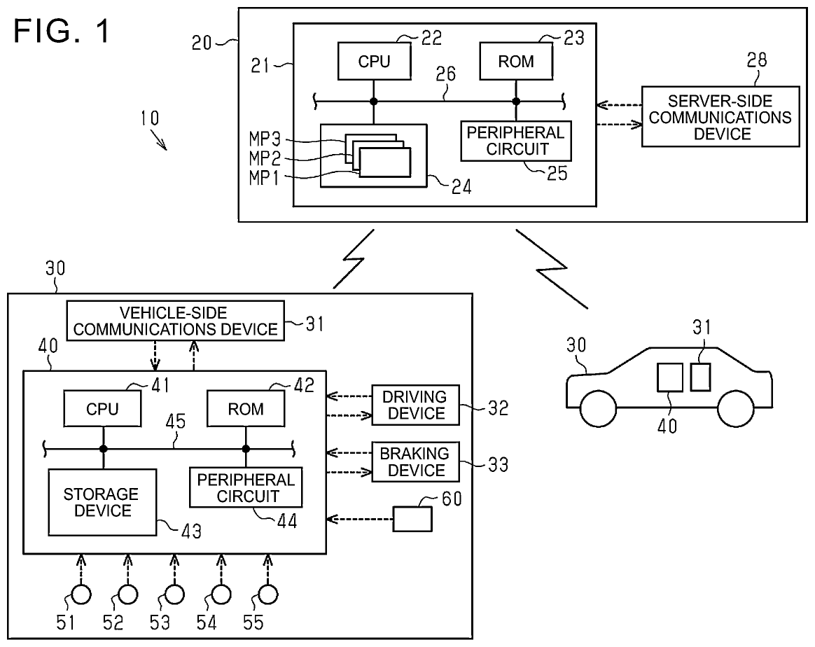

The following describes a first embodiment of a running support system for a vehicle and a running support method for a vehicle with reference to FIGS. 1 to 7.

Overall Configuration

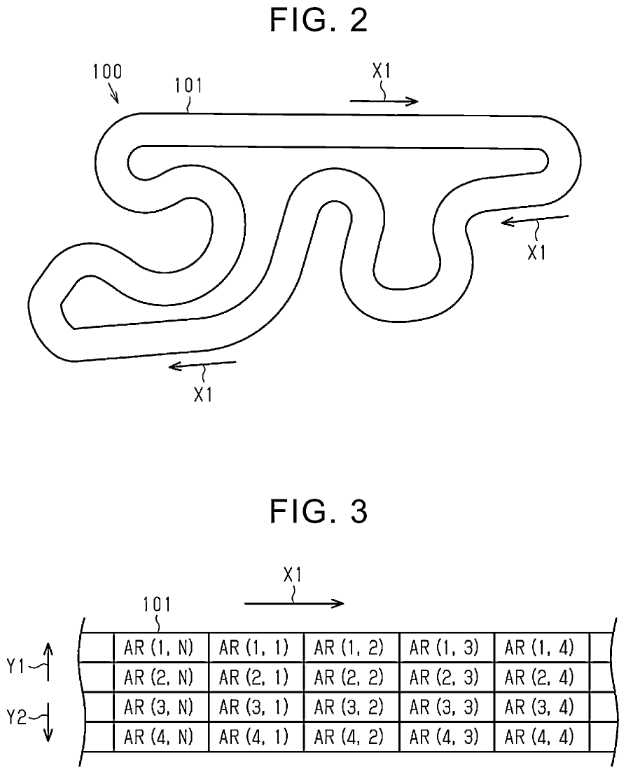

As illustrated in FIG. 1, a running support system 10 includes a server control device 21 of a server 20 provided outside a vehicle, and a vehicle control device 40 provided in a vehicle 30. The server 20 can transmit and receive various pieces of information to and from the vehicle control device 40 of the vehicle 30 running along a course 101 in a circuit field 100 illustrated in FIG. 2. That is, in a case where a plurality of vehicles 30 is running along the course 101, the server 20 transmits and receives various pieces of information to and from respective vehicle control devices 40 of the vehicles 30.

Configuration of Vehicle 30

As illustrated in FIG. 1, the vehicle 30 includes a vehicle-side communications device 31, a driving device 32, and a braking device 33 in addition to the vehicle control device 40. The driving device 32 adjusts driving force of the vehicle 30. The braking device 33 adjusts braking force of the vehicle 30.

The vehicle-side communications device 31 transmits information output from the vehicle control device 40 to the server 20. Further, the vehicle-side communications device 31 receives information transmitted from the server 20 and outputs the information to the vehicle control device 40.

The vehicle control device 40 includes a CPU 41, a ROM 42, a storage device 43 as an electrically rewritable nonvolatile memory, and a peripheral circuit 44. The CPU 41, the ROM 42, the storage device 43, and the peripheral circuit 44 are communicable with each other via a local network 45. In the ROM 42, a control program to be executed by the CPU 41 is stored. In the storage device 43, various maps, tables, and so on are stored. The peripheral circuit 44 includes a circuit configured to generate a clock signal defining an inside operation, a power circuit, a reset circuit, and so on.

The vehicle 30 includes various sensors configured to output a detection signal to the vehicle control device 40. The sensors can include, for example, a vehicle speed sensor 51, a front-rear acceleration sensor 52, a lateral acceleration sensor 53, a yaw rate sensor 54, and a steering angle sensor 55. The vehicle speed sensor 51 detects a vehicle speed V as a traveling speed of the vehicle 30 and outputs a detection signal corresponding to a detection result. The front-rear acceleration sensor 52 detects a front-rear acceleration Gx of the vehicle 30 and outputs a detection signal corresponding to a detection result. The lateral acceleration sensor 53 detects a lateral acceleration Gy of the vehicle 30 and outputs a detection signal corresponding to a detection result. The yaw rate sensor 54 detects a yaw rate Yr of the vehicle 30 and outputs a detection signal corresponding to a detection result. The steering angle sensor 55 detects a steering angle Str of a steering wheel of the vehicle 30 and outputs a detection signal corresponding to a detection result.

The vehicle 30 includes a GPS receiver 60. The GPS receiver 60 receives, from a GPS satellite, a GPS signal that is a signal on a current position coordinate CP of the vehicle 30 and outputs the GPS signal to the vehicle control device 40. The vehicle control device 40 acquires the current position coordinate CP of the vehicle 30 based on the GPS signal and transmits position information that is information on the position coordinate CP to the vehicle-side communications device 31 via the server 20.

In the present embodiment, in a case where the vehicle 30 is running along the course 101 illustrated in FIG. 2, the vehicle control device 40 supports a vehicle operation performed by a driver based on a vehicle speed appropriate value VL for a currently-running area that is a running area where the vehicle 30 is currently running. For example, the vehicle control device 40 notifies the driver of the vehicle speed appropriate value VL, or in a case where the vehicle speed V exceeds the vehicle speed appropriate value VL, the vehicle control device 40 decelerates the vehicle 30. The vehicle speed appropriate value VL is an appropriate vehicle speed at the time when the vehicle 30 runs in the currently-running area. When the currently-running area changes, the vehicle speed appropriate value VL can change, and this will be described later in detail. Further, the vehicle operation includes at least steering among steering, an accelerator operation, and a brakes operation.

Configuration of Server 20

As illustrated in FIG. 1, the server 20 includes a server-side communications device 28 in addition to the server control device 21. The server-side communications device 28 transmits information output from the server control device 21 to the vehicle 30. Further, the server-side communications device 28 receives information transmitted from the vehicle 30 and outputs the information to the server control device 21.

The server control device 21 includes a CPU 22, a ROM 23, a storage device 24 as an electrically rewritable nonvolatile memory, and a peripheral circuit 25. The CPU 22, the ROM 23, the storage device 24, and the peripheral circuit 25 are communicable with each other via a local network 26. In the ROM 23, a control program to be executed by the CPU 22 is stored. In the storage device 24, various pieces of information necessary to set the vehicle speed appropriate value VL are stored. The peripheral circuit 25 includes a circuit configured to generate a clock signal defining an inside operation, a power circuit, a reset circuit, and so on.

In the storage device 24, the course 101 illustrated in FIG. 2 is stored such that the course 101 is divided into a plurality of running areas AR. In FIG. 3, some parts of the course 101 are schematically illustrated. As illustrated in FIG. 3, the running areas AR(1,1), . . . , (1,N), (2,1), . . . , (2,N), (3,1), . . . , (3,N), (4,1), . . . , (4,N), are stored in the storage device 24. Note that “N” is the number of divisions of the course 101 in an advancing direction X1 of the vehicle 30. In the present embodiment, an integer of “5” or more is set as “N.”

In the present embodiment, a plurality of running areas AR is set at the same position in the advancing direction X1. For example, four running areas AR(1,1), AR(2,1), AR(3,1), AR(4,1) are placed at the same position in the advancing direction X1. Among the running areas AR(1,1), AR(2,1), AR(3,1), AR(4,1), the running area AR(1,1) is placed at a position closest to an outer side Y1, and the running area AR(2,1) is placed at a position second closest to the outer side Y1. Further, the running area AR(3,1) is placed at a position third closest to the outer side Y1, and the running area AR(4,1) is placed at a position closest to an inner side Y2. Further, the running area AR(1,2) is placed ahead of the running area AR(1,1) in the advancing direction X1, and the running area AR(2,2) is placed ahead of the running area AR(2,1) in the advancing direction X1.

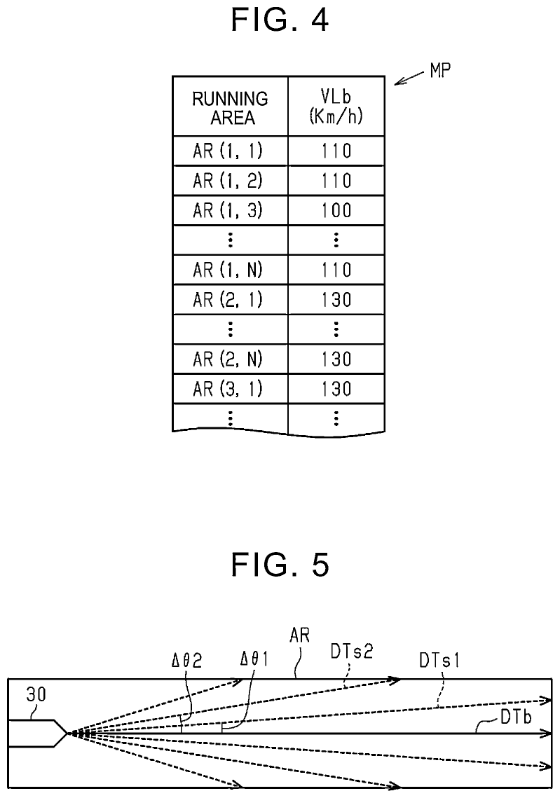

Further, the storage device 24 includes a map MP in which respective reference vehicle speed appropriate value VLb for the running areas AR are stored as references for the vehicle speed appropriate value VL. FIG. 4 illustrates an example of the map MP. As illustrated in FIG. 4, for example, “110 km/h” is set as the reference vehicle speed appropriate value VLb for the running area AR(1,1). Further, “110 km/h” is set as the reference vehicle speed appropriate value VLb for the running area AR(1,2). Further, “100 km/h” is set as the reference vehicle speed appropriate value VLb for the running area AR(1,3). Further, “130 km/h” is set as the reference vehicle speed appropriate value VLb for the running area AR(2,1). Further, “130 km/h” is set as the reference vehicle speed appropriate value VLb for the running area AR(3,1).

In the present embodiment, as illustrated in FIG. 1, the map MP as described above is prepared for each vehicle type. That is, a map MP1 is prepared as a map for a first vehicle type, and a map MP2 is prepared as a map for a second vehicle type. Further, a map MP3 is prepared as a map for a third vehicle type. The storage device 24 includes the maps MP1, MP2, MP3.

Further, in the storage device 24, a reference advancing direction DTb indicated by a continuous line in FIG. 5 is stored for each running area AR. The reference advancing direction DTb is a reference advancing direction for the vehicle 30 at the time when the vehicle 30 runs in the running area AR. An advancing direction, for the vehicle 30 in the running area AR, that allows the vehicle 30 to run fast in the course 101 is set as the reference advancing direction DTb. For example, the reference advancing direction DTb for each running area AR is set based on a record line of the course 101. The record line is an ideal running line to cause the vehicle 30 to run along the course 101 in the fastest lap time. In a running area AR where the record line runs, a direction along the record line should be set as the reference advancing direction DTb. In a running area AR where the record line does not run, a direction along which the course of the vehicle 30 gradually approaches the record line should be set as the reference advancing direction DTb.

Procedure of Process to Support Vehicle Operation Performed by Driver by Setting Vehicle Speed Appropriate Value VL

Prior to running of the vehicle 30 along the course 101, the vehicle control device 40 transmits information on the vehicle type of the vehicle 30 to the server 20 via the vehicle-side communications device 31. Further, in a case where the vehicle 30 is running along the course 101, the vehicle control device 40 sequentially transmits position information on a current position coordinate CP of the vehicle 30 to the server 20 via the vehicle-side communications device 31. Then, the server control device 21 of the server 20 sets a vehicle speed appropriate value VLa based on the position coordinate CP of the vehicle 30 and transmits the vehicle speed appropriate value VLa to the vehicle 30.

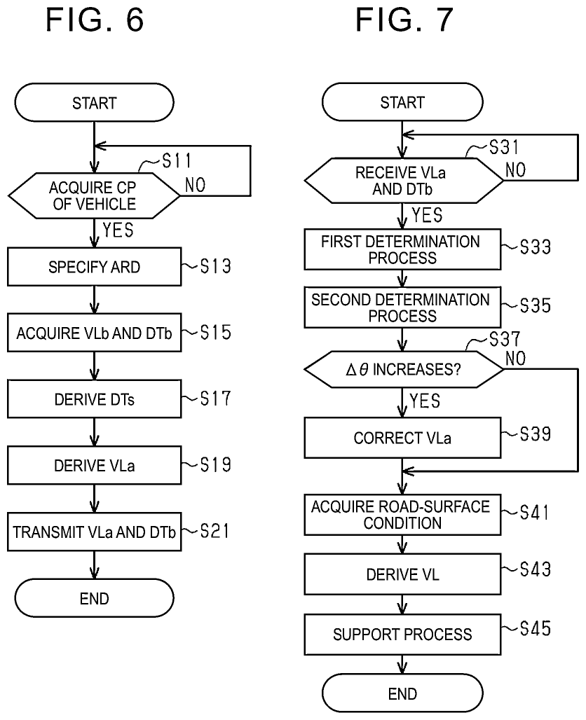

FIG. 6 illustrates a processing routine to be executed by the CPU 22 of the server control device 21. The CPU 22 repeatedly executes this processing routine. In this processing routine, first, in step S11, the CPU 22 determines whether or not the CPU 22 acquires the current position coordinate CP of the vehicle 30. In a case where the CPU 22 does not acquire the position coordinate CP (S11: NO), the CPU 22 repeatedly executes the determination of step S11 until the CPU 22 can acquire the position coordinate CP. In the meantime, in a case where the CPU 22 acquires the position coordinate CP (S11: YES), the CPU 22 advances the process to step S13. In step S13, the CPU 22 specifies a currently-running area ARD as a running area where the vehicle 30 is running at present from among all the running areas AR, based on the acquired position coordinate CP. For example, the CPU 22 selects a running area AR including the acquired position coordinate CP as the currently-running area ARD.

Subsequently, in step S15, the CPU 22 acquires a reference vehicle speed appropriate value VLb and a reference advancing direction DTb based on the currently-running area ARD. That is, the CPU 22 acquires the reference vehicle speed appropriate value VLb for the running area AR specified as the currently-running area ARD from the map MP in the storage device 24. For example, the CPU 22 selects a map corresponding to the vehicle type of the vehicle 30 from a plurality of maps MP included in the storage device 24 and acquires the reference vehicle speed appropriate value VLb from the map thus selected. Further, the CPU 22 acquires the reference advancing direction DTb for the running area AR specified as the currently-running area ARD from the storage device 24.

In subsequent step S17, the CPU 22 derives an advancing direction DTs of the vehicle 30. For example, the CPU 22 can derive the advancing direction DTs based on a transition of the position coordinate CP to be received by the server 20.

Then, in step S19, the CPU 22 derives the vehicle speed appropriate value VLa based on the reference vehicle speed appropriate value VLb, the reference advancing direction DTb, and the advancing direction DTs of the vehicle 30. For example, the CPU 22 determines whether the reference advancing direction DTb accords with the advancing direction DTs or not. In a case where the reference advancing direction DTb is determined not to accord with the advancing direction DTs, the CPU 22 derives, as a correction value H1, a value larger than a value to be derived in a case where the reference advancing direction DTb is determined to accord with the advancing direction DTs. Then, the CPU 22 derives, as the vehicle speed appropriate value VLa, a value obtained by subtracting the correction value H1 from the reference vehicle speed appropriate value VLb. Hereby, in a case where the advancing direction DTs does not accord with the reference advancing direction DTb, the CPU 22 can set, as the vehicle speed appropriate value VLa, a value smaller than a value to be set in a case where the advancing direction DTs accords with the reference advancing direction DTb.

Note that the CPU 22 changes the correction value H1 in accordance with a deviation amount between the reference advancing direction DTb and the advancing direction DTs. More specifically, as the deviation amount is larger, the CPU 22 derives a larger value as the correction value HE Hereby, as the deviation amount is larger, the CPU 22 can derive a smaller value as the vehicle speed appropriate value VLa.

For example, as illustrated in FIG. 5, the CPU 22 derives, as a deviation amount 40, an angle formed between the reference advancing direction DTb and the advancing direction DTs. The deviation amount 40 in a case where the advancing direction DTs is a first direction DTs1 is taken as a first deviation amount 401, the deviation amount 40 in a case where the advancing direction DTs is a second direction DTs2 is taken as a second deviation amount 402, and the second deviation amount 402 is larger than the first deviation amount 401. In this case, in a case where the advancing direction DTs is the second direction DTs2, the CPU 22 derives, as the correction value H1, a value larger than a value to be set in a case where the advancing direction DTs is the first direction DTs1.

Referring back to FIG. 6, after the vehicle speed appropriate value VLa is derived in step S19, the CPU 22 advances the process to step S21. In step S21, the CPU 22 transmits the vehicle speed appropriate value VLa and the reference advancing direction DTb from the server-side communications device 28 to the vehicle 30. After that, the CPU 22 ends this processing routine once.

When the vehicle control device 40 receives the vehicle speed appropriate value VLa and the reference advancing direction DTb from the server 20, the vehicle control device 40 determines a vehicle speed appropriate value VL and executes a support process based on the vehicle speed appropriate value VL. FIG. 7 illustrates a processing routine to be executed by the CPU 41 of the vehicle control device 40. The CPU 41 repeatedly executes this processing routine.

In this processing routine, first, in step S31, the CPU 41 determines whether or not the CPU 41 has received the vehicle speed appropriate value VLa and the reference advancing direction DTb from the server 20. In a case where the CPU 41 has not received the vehicle speed appropriate value VLa and the reference advancing direction DTb (S31: NO), the CPU 41 repeatedly executes the determination of step S31 until the CPU 41 has received them. In the meantime, in a case where the CPU 41 has received the vehicle speed appropriate value VLa and the reference advancing direction DTb (S31: YES), the CPU 41 advances the process to step S33.

In step S33, the CPU 41 executes a first determination process. In the first determination process, the CPU 41 determines whether the advancing direction DTs of vehicle 30 deviates from the reference advancing direction DTb or not, based on the lateral acceleration Gy and the yaw rate Yr of the vehicle 30. That is, the CPU 41 predicts how the advancing direction DTs changes, based on the lateral acceleration Gy and the yaw rate Yr. Then, in a case where the CPU 41 predicts that the advancing direction DTs changes so that a deviation between the advancing direction DTs and the reference advancing direction DTb increases, the CPU 41 determines that the advancing direction DTs deviates from the reference advancing direction DTb. In the meantime, in a case where the CPU 41 cannot predict that the advancing direction DTs changes so that the deviation between the advancing direction DTs and the reference advancing direction DTb increases, the CPU 41 determines that the advancing direction DTs does not deviate from the reference advancing direction DTb. In a case where the CPU 41 determines that the advancing direction DTs deviates from the reference advancing direction DTb, the CPU 41 turns on a first determination flag. In the meantime, in a case where the CPU 41 determines that the advancing direction DTs does not deviate from the reference advancing direction DTb, the CPU 41 turns off the first determination flag. Then, the CPU 41 ends the first determination process.

Subsequently, in step S35, the CPU 41 executes a second determination process. In the second determination process, the CPU 41 determines whether the advancing direction DTs of the vehicle 30 deviates from the reference advancing direction DTb or not, based on the steering angle Str. That is, the CPU 41 predicts how the advancing direction DTs changes, based on the steering angle Str. In a case where the CPU 41 predicts that the advancing direction DTs changes so that the deviation between the advancing direction DTs and the reference advancing direction DTb increases, the CPU 41 determines that the advancing direction DTs deviates from the reference advancing direction DTb. Meanwhile, in a case where the CPU 41 cannot predict that the advancing direction DTs changes so that the deviation between the advancing direction DTs and the reference advancing direction DTb increases, the CPU 41 determines that the advancing direction DTs does not deviate from the reference advancing direction DTb. In a case where the CPU 41 determines that the advancing direction DTs deviates from the reference advancing direction DTb, the CPU 41 turns on a second determination flag. In the meantime, in a case where the CPU 41 determines that the advancing direction DTs does not deviate from the reference advancing direction DTb, the CPU 41 turns off the second determination flag. Then, the CPU 41 ends the second determination process.

In subsequent step S37, the CPU 41 determines whether the deviation amount Δθ between the advancing direction DTs of the vehicle 30 and the reference advancing direction DTb increases or not. In a case where at least either one of the first determination flag and the second determination flag is turned on, the CPU 41 determines that the deviation amount Δθ increases. In the meantime, in a case where the first determination flag and the second determination flag are both turned off, the CPU 41 determines that the deviation amount Δθ does not increase. In a case where the CPU 41 determines that the deviation amount Δθ increases (S37: YES), the CPU 41 advances the process to step S39. In the meantime, in a case where the CPU 41 determines that the deviation amount Δθ does not increase (S37: NO), the CPU 41 advances the process to step S41.

In step S39, the CPU 41 corrects the vehicle speed appropriate value VLa. The CPU 41 derives, as a corrected vehicle speed appropriate value VLa, a value obtained by subtracting a correction value H2 from the vehicle speed appropriate value VLa. For example, as a predicted increase speed of the deviation amount Δθ is larger, the CPU 41 derives a larger value as the correction value H2. That is, in the present embodiment, in a case where the CPU 41 determines that the deviation amount Δθ increases, the CPU 41 derives, as the vehicle speed appropriate value VLa, a value smaller than a value to be derived in a case where the CPU 41 determines that the deviation amount Δθ does not increase. Then, the CPU 41 advances the process to step S41.

In step S41, the CPU 41 acquires a road-surface condition of the currently-running area ARD. In the present embodiment, the CPU 41 acquires an estimated value of a road surface μ as the road-surface condition. For example, in a case where a driving force is input into wheels of the vehicle 30, the CPU 41 can derive an estimated value of the road surface μ based on the driving force and a slip amount of the wheels.

Then, in step S43, the CPU 41 derives the vehicle speed appropriate value VL based on the vehicle speed appropriate value VLa and the road-surface condition. In a case where the CPU 41 acquires the estimated value of the road surface μ as the road-surface condition, the CPU 41 determines whether or not the estimated value of the road surface μ is equal to or more than a μ-determination value, for example. The μ-determination value is set as a determination reference based on which it is determined whether the road surface is a low μ-road or not. In a case where the estimated value of the road surface μ is less than the μ-determination value, the CPU 41 regards the road surface as the low μ-road. In a case where the estimated value of the road surface μ is equal to or more than the μ-determination value, the CPU 41 does not regard the road surface as the low μ-road. In a case where the estimated value of the road surface μ is less than the μ-determination value, the CPU 41 sets a positive value as an adjustment value H3. In the meantime, in a case where the estimated value of the road surface μ is equal to or more than the μ-determination value, the CPU 41 sets “0” as the adjustment value H3. Then, the CPU 41 derives, as the vehicle speed appropriate value VL, a value obtained by subtracting the adjustment value H3 from the vehicle speed appropriate value VLa.

As described above, in a case where the advancing direction DTs of the vehicle 30 does not accord with the reference advancing direction DTb, a value smaller than a value to be set in a case where the advancing direction DTs accords with the reference advancing direction DTb is set as the vehicle speed appropriate value VLa. Further, in a case where the deviation amount Δθ is determined to increase, a value smaller than a value to be set in a case where the deviation amount Δθ is determined not to increase is set as the vehicle speed appropriate value VLa. Accordingly, in the present embodiment, in a case where the advancing direction DTs does not accord with the reference advancing direction DTb, a value smaller than a value to be set in a case where the advancing direction DTs accords with the reference advancing direction DTb is set as the vehicle speed appropriate value VL. Further, in a case where the deviation amount Δθ is determined to increase, a value smaller than a value to be set in a case where the deviation amount Δθ is determined not to increase is set as the vehicle speed appropriate value VL.

When the vehicle speed appropriate value VL is derived in step S43, the CPU 41 advances the process to step S45. In step S45, the CPU 41 executes the support process. In the present embodiment, the CPU 41 notifies the driver of the vehicle speed appropriate value VL. Further, in a case where the vehicle speed V exceeds the vehicle speed appropriate value VL, the CPU 41 decelerates the vehicle 30 by controlling at least either one of the driving device 32 and the braking device 33. After that, the CPU 41 ends this processing routine once.

Correspondence

The correspondence between what is described in the present embodiment and what is described in the field of SUMMARY is as follows.

Step S13 corresponds to the “specifying process” of specifying the currently-running area ARD from among the running areas AR. Steps S19, S33, S35, S37, S39 correspond to the “appropriate value setting process” of setting the vehicle speed appropriate value VLa. Step S45 corresponds to the “support process” of at least either notifying the driver of the vehicle speed appropriate value VL or decelerating the vehicle 30 in a case where the vehicle speed V exceeds the vehicle speed appropriate value VL. Step S41 corresponds to the “road-surface condition acquisition process” of acquiring the road-surface condition in the currently-running area ARD. Step S43 corresponds to the “correction process” of correcting the vehicle speed appropriate value VLa set in the appropriate value setting process based on the road-surface condition in the currently-running area ARD.

Further, the storage device 24 of the server control device 21 corresponds to the “storage device” in which the running areas AR, respective reference advancing directions DTb for the running areas AR, and respective reference vehicle speed appropriate values VLb for the running areas AR are stored. Further, the CPU 22 of the server control device 21 and the CPU 41 of the vehicle control device 40 correspond to the “execution device” configured to execute the above processes. Further, the CPU 41 of the vehicle control device 40 corresponds to the “second execution device” configured to execute some of the above processes, and the CPU 22 of the server control device 21 corresponds to the “first execution device” configured to execute remaining processes of the above processes.

Operations and Effects

Next will be described operations and effects of the present embodiment.

(1-1) In a case where the vehicle 30 runs along the course 101 illustrated in FIG. 2, the currently-running area ARD is specified from among the running areas AR set by dividing the course 101. The vehicle speed appropriate value VL is set based on the currently-running area ARD. Then, due to the support process, the vehicle speed appropriate value VL is notified to the driver, or the vehicle 30 is decelerated so that the vehicle speed V does not exceed the vehicle speed appropriate value VL.

In the present embodiment, the vehicle speed appropriate value VL is set as follows. That is, in a case where the reference advancing direction DTb of the currently-running area ARD does not accord with the advancing direction DTs of the vehicle 30, a value smaller than a value to be set in a case where the reference advancing direction DTb accords with the advancing direction DTs is set as the vehicle speed appropriate value VL. That is, the vehicle speed appropriate value VL is set in consideration of the advancing direction DTs of the vehicle 30 as well as the currently-running area ARD. Accordingly, when the advancing direction DTs changes, the vehicle speed appropriate value VL also changes.

Thus, in the present embodiment, the vehicle speed appropriate value VL can be set to have magnitude in consideration of the advancing direction DTs of the vehicle 30. This makes it possible to support the vehicle operation performed by the driver in consideration of the currently-running area ARD and the track of the vehicle 30 inside the currently-running area ARD.

(1-2) When the driver performs steering, the lateral acceleration Gy and the yaw rate Yr of the vehicle 30 change. Further, at the time when disturbance is input in the vehicle 30, the lateral acceleration Gy and the yaw rate Yr of the vehicle 30 may also change. The disturbance as used herein indicates that the vehicle 30 receives crosswind, that the wheels of the vehicle 30 clime over irregularities on a road, or the like. When at least one of the lateral acceleration Gy and the yaw rate Yr changes, the advancing direction DTs of the vehicle 30 may change.

In view of this, in the present embodiment, whether the deviation amount Δθ between the advancing direction DTs of the vehicle 30 and the reference advancing direction DTb increases or not is determined based on the lateral acceleration Gy and the yaw rate Yr of the vehicle 30. Then, in a case where the deviation amount Δθ is determined to increase, a value smaller than a value to be set in a case where the deviation amount Δθ is determined not to increase is set as the vehicle speed appropriate value VL. That is, the vehicle speed appropriate value VL can be set in consideration of a change in the advancing direction DTs, the change being predictable based on the lateral acceleration Gy and the yaw rate Yr of the vehicle 30.

(1-3) Assume a case where the correction of the vehicle speed appropriate value VLa based on the determination result from the first determination process is executed by the server control device 21. In this case, the lateral acceleration Gy and the yaw rate Yr that are information necessary for execution of the first determination process are transmitted to the server 20. However, since a time lag occurs due to transmission and reception of the lateral acceleration Gy and the yaw rate Yr, the correction of the vehicle speed appropriate value VLa is easily delayed. In this regard, in the present embodiment, the correction of the vehicle speed appropriate value VLa based on the determination result from the first determination process is executed by the vehicle control device 40. Accordingly, it is possible to restrain the delay in the correction of the vehicle speed appropriate value VLa.

(1-4) Whether the deviation amount Δθ between the advancing direction DTs of the vehicle 30 and the reference advancing direction DTb increases or not is determined based on the steering angle Str. In a case where the deviation amount Δθ is determined to increase, a value smaller than a value to be set in a case where the deviation amount Δθ is determined not to increase can be set as the vehicle speed appropriate value VL. That is, the vehicle speed appropriate value VL can be set in consideration of a change in the advancing direction DTs, the change being predictable based on the steering of the driver.

(1-5) Assume a case where the correction of the vehicle speed appropriate value VLa based on the determination result from the second determination process is executed by the server control device 21. In this case, the steering angle Str that is information necessary for execution of the second determination process is transmitted to the server 20. However, since a time lag occurs due to transmission and reception of the steering angle Str, the correction of the vehicle speed appropriate value VLa is easily delayed. In this regard, in the present embodiment, the correction of the vehicle speed appropriate value VLa based on the determination result from the second determination process is executed by the vehicle control device 40. Accordingly, it is possible to restrain the delay in the correction of the vehicle speed appropriate value VLa.

(1-6) In a case where the vehicle 30 runs on a road with a small μ value, the vehicle behavior is easily disturbed. In other words, in order to secure stability in the vehicle behavior, it is preferable to restrain the vehicle speed V from becoming too large in a case where the road surface μ where the vehicle runs is small. In view of this, in the present embodiment, in a case where the road surface μ is small, a value smaller than a value to be set in a case where the road surface μ is not small can be set as the vehicle speed appropriate value VL. Accordingly, it is possible to support the vehicle operation performed by the driver in consideration of the road surface μ.

(1-7) In the present embodiment, different maps MP are prepared for respective vehicle types. On this account, the vehicle speed appropriate value VL can be set to have magnitude suitable for the vehicle type. That is, it is possible to support the vehicle operation performed by the driver in accordance with the vehicle type.

(1-8) In the present embodiment, the vehicle speed appropriate value VL is set in collaboration with the server control device 21 and the vehicle control device 40. On this account, in comparison with a case where various processes to set the vehicle speed appropriate value VL are executed by one control device, it is possible to reduce control loads to the control devices 21, 40.

### Second Embodiment

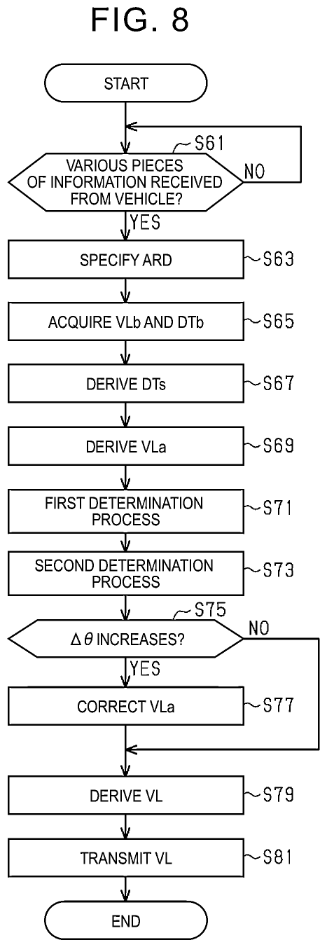

The following describes a second embodiment of the running support system and the running support method with reference to FIG. 8. In the following description, parts different from the first embodiment will be mainly described. The same constituent as or a constituent equivalent to a constituent described in the first embodiment has the same reference sign as the constituent described in the first embodiment, and redundant descriptions about the constituent will be omitted.

Procedure of Process to Support Vehicle Operation of Driver by Setting Vehicle Speed Appropriate Value VL

In a case where the vehicle 30 is running along the course 101, the vehicle control device 40 sequentially transmits information necessary to set the vehicle speed appropriate value VL to the server 20 via the vehicle-side communications device 31. The information necessary to derive the vehicle speed appropriate value VL can include, for example, the position coordinate CP, the steering angle Str, the lateral acceleration Gy, the yaw rate Yr, and an estimated value of the road surface μ.

FIG. 8 illustrates a processing routine to be executed by the CPU 22 of the server control device 21. The CPU 22 repeatedly executes this processing routine. In this processing routine, first, in step S61, the CPU 22 determines whether the CPU 22 has received various pieces of information from the vehicle 30. The various pieces as used herein is the information necessary to derive the vehicle speed appropriate value VL. In a case where the CPU 22 has not received the various pieces of information (S61: NO), the CPU 22 repeatedly executes the determination of step S61 until the CPU 22 has received the various pieces of information. In the meantime, in a case where the CPU 22 has received the various pieces of information (S61: YES), the CPU 22 advances the process to step S63.

In step S63, the CPU 22 specifies the currently-running area ARD based on the position coordinate CP, similarly to step S13. Subsequently, in step S65, the CPU 22 acquires the reference vehicle speed appropriate value VLb and the reference advancing direction DTb based on the currently-running area ARD, similarly to step S15. In subsequent step S67, the CPU 22 derives the advancing direction DTs of the vehicle 30, similarly to step S17. Then, in step S69, the CPU 22 derives the vehicle speed appropriate value VLa based on the reference vehicle speed appropriate value VLb, the reference advancing direction DTb, and the advancing direction DTs of the vehicle 30, similarly to step S19.

In subsequent step S71, the CPU 22 executes the first determination process, similarly to step S33. In the present embodiment, the first determination process is executed by the server control device 21, instead of the vehicle control device 40.

Subsequently, in step S73, the CPU 22 executes the second determination process, similarly to step S35. In the present embodiment, the second determination process is executed by the server control device 21, instead of the vehicle control device 40.

Then, in step S75, the CPU 22 determines whether or not the deviation amount Δθ between the advancing direction DTs of the vehicle 30 and the reference advancing direction DTb increases, similarly to step S37. In a case where the CPU 22 determines that the deviation amount Δθ increases (S75: YES), the CPU 22 advances the process to step S77. In the meantime, in a case where the CPU 22 determines that the deviation amount Δθ does not increase (S75: NO), the CPU 22 advances the process to step S79.

In step S77, the CPU 22 corrects the vehicle speed appropriate value VLa, similarly to step S39. After the vehicle speed appropriate value VLa is corrected, the CPU 22 advances the process to step S79.

In step S79, the CPU 22 derives the vehicle speed appropriate value VL based on the vehicle speed appropriate value VLa derived in step S77, and the road-surface condition received in step S61, similarly to step S43. Subsequently, in step S81, the CPU 22 causes the server-side communications device 28 to transmit the vehicle speed appropriate value VL to the vehicle 30. After that, the CPU 22 ends this processing routine once.

The CPU 41 of the vehicle control device 40 executes the support process based on the vehicle speed appropriate value VL received from the server 20. Details of the support process are similar to the details of the support process in the first embodiment.

Correspondence

The correspondence between what is described in the present embodiment and what is described in the field of SUMMARY is as follows.

Step S63 corresponds to the “specifying process.” Steps S69, S71, S73, S75, S77 correspond to the “appropriate value setting process.” Step S79 corresponds to the “correction process.”

Further, the storage device 24 of the server control device 21 corresponds to the “storage device” in which the running areas AR, respective reference advancing directions DTb for the running areas AR, and respective reference vehicle speed appropriate values VLb for the running areas AR are stored. Further, the CPU 22 of the server control device 21 and the CPU 41 of the vehicle control device 40 correspond to the “execution device” configured to execute the above processes. Further, the CPU 41 of the vehicle control device 40 corresponds to the “second execution device” configured to execute some of the above processes, and the CPU 22 of the server control device 21 corresponds to the “first execution device” configured to execute remaining processes of the above processes.

Operations and Effects

The present embodiment can achieve the following effect in addition to effects similar to the effects of (1-1), (1-2), (1-4), (1-6), and (1-7) of the first embodiment.

(2-1) In the present embodiment, the processes until the vehicle speed appropriate value VL is set are executed by the server control device 21. On this account, in comparison with the first embodiment, a control load to the CPU 41 of the vehicle control device 40 can be reduced.

### Modifications

The embodiments can also be carried out by adding changes as stated below. The embodiments and the following modifications can be carried out in combination as long as they do not cause any technical inconsistencies.
In each of the above embodiments, various processes constituting the running support method are executed by the CPU 22 of the server control device 21 and the CPU 41 of the vehicle control device 40 in a divided manner. However, all the processes constituting the running support method may be executed by the CPU 41 of the vehicle control device 40.

In this case, in a case where the vehicle 30 runs along the course 101 managed by the server 20, all the running areas AR illustrated in FIG. 3, respective reference vehicle speed appropriate values VLb for the running areas AR, and respective reference advancing directions DTb for the running areas AR are transmitted from the server 20 to the vehicle 30 prior to the start of running. Then, various pieces of received information are stored in the storage device 43 of the vehicle control device 40.

In a case where the vehicle 30 is running along the course 101 in this state, the CPU 41 can set the vehicle speed appropriate value VL similarly to the above embodiments.

In this modification, the CPU 41 of the vehicle control device 40 corresponds to the “execution device,” and the storage device 43 corresponds to the “storage device.”
In each of the above embodiments, different maps MP are prepared for respective vehicle types, but it is not necessary to prepare the different maps MP for the respective vehicle types.
In a case where the vehicle speed appropriate value VL is corrected in accordance with the road-surface condition, the vehicle speed appropriate value VL may be corrected in accordance with the road-surface condition by use of a technique different from the technique described in each of the above embodiments. For example, the vehicle speed appropriate value VL may be corrected so that a correction amount is larger as the road surface μ is lower.
The vehicle speed appropriate value VL may be derived without consideration of the road-surface condition. That is, the correction process may be omitted.

In this case, the road-surface condition acquisition process may be omitted.
In the first determination process, whether the deviation amount Δθ increases or not may be determined by use of only one of the lateral acceleration Gy and the yaw rate Yr.
The first determination process may be omitted, provided that the second determination process is executed.
The second determination process may be omitted, provided that the first determination process is executed.
In each of the above embodiments, in a case where it is predicted that the deviation amount Δθ between the advancing direction DTs of the vehicle 30 and the reference advancing direction DTb increases, the vehicle speed appropriate value VL is made small. However, it is not necessary to take into consideration whether or not it is predictable that the deviation amount Δθ increases, at the time of deriving the vehicle speed appropriate value VL. In this case, the first determination process and the second determination process may not be executed.
In each of the above embodiments, as the increase speed of the deviation amount Δθ between the advancing direction DTs of the vehicle 30 and the reference advancing direction DTb is larger, a smaller value is set as the vehicle speed appropriate value VL. However, the applicable embodiment is not limited to this. For example, in a case where the increase speed of the deviation amount Δθ is equal to or more than a threshold, the same value may be set as the vehicle speed appropriate value VL regardless of the magnitude of the increase speed. Even in this case, in a case where the advancing direction DTs does not accord with the reference advancing direction DTb, a value smaller than a value to be set in a case where the advancing direction DTs accords with the reference advancing direction DTb can be set as the vehicle speed appropriate value VL.
As the support process, the process of decelerating the vehicle 30 in a case where the vehicle speed V exceeds the vehicle speed appropriate value VL may not be executed, provided that the driver is notified of the vehicle speed appropriate value VL.
As the support process, the process of notifying the driver of the vehicle speed appropriate value VL may not be executed, provided that the process of decelerating the vehicle 30 is executed in a case where the vehicle speed V exceeds the vehicle speed appropriate value VL.
The above embodiments deal with a case where a vehicle runs along the course 101 in the circuit field 100. However, the applicable embodiment is not limited to this. For example, the running support system may be applied to a case where the vehicle 30 runs on a public road.

In a case where the vehicle 30 runs on a road having a plurality of lanes, the road is divided into a traffic lane and a passing lane. That is, the traffic lane and the passing lane are set as running areas. A reference vehicle speed appropriate value VLb for the traffic lane and a reference vehicle speed appropriate value VLb for the passing lane are prepared. Further, a reference advancing direction DTb for the traffic lane and a reference advancing direction DTb for the passing lane are prepared. In this case, a value larger than the reference vehicle speed appropriate value VLb for the passing lane should be set as the reference vehicle speed appropriate value VLb for the traffic lane. Further, a direction along the traffic lane should be set as the reference advancing direction DTb for the traffic lane, and a direction along the passing lane should be set as the reference advancing direction DTb for the passing lane.

For example, in a case where the vehicle 30 is running in the traffic lane, the vehicle speed appropriate value VL is set based on the reference vehicle speed appropriate value VLb for the traffic lane and a determination result on whether or not the reference advancing direction DTb for the traffic lane accords with an actual advancing direction DTs of the vehicle 30. In this configuration, in a case where the vehicle 30 travels in the traffic lane in a direction approaching its adjacent lane, the advancing direction DTs is determined not to accord with the reference advancing direction DTb for the traffic lane. Accordingly, a value smaller than the reference vehicle speed appropriate value VLb is set as the vehicle speed appropriate value VL.
The running support system 10 is not limited to a system including a CPU and a memory in which a program is stored and configured to execute a software process. That is, the running support system 10 should have any of the following configurations (a) to (c).

(a) The running support system 10 includes one or more processors configured to execute various processes in accordance with a computer program. The processor includes a CPU and a memory such as a RAM or a ROM. A program code or a command configured to cause the CPU to execute a process is stored in the memory. The memory, that is, a computer-readable medium includes all available media accessible by a general-purpose or exclusive computer.

(b) The running support system 10 includes one or more exclusive hardware circuitry configured to execute various processes. The exclusive hardware circuitry can include, for example, an application specific integrated circuit, namely, ASIC, or FPGA. Note that the “ASIC” is an abbreviation of Application Specific Integrated Circuit. The “FPGA” is an abbreviation of Field-Programmable Gate Array.

(c) The running support system 10 includes a processor configured to execute some of various processes in accordance with a computer program, and an exclusive hardware circuitry configured to execute remaining processes of the various processes.

What is claimed is:

1. A running support system for a vehicle, the running support system being for supporting a vehicle operation performed by a driver during vehicle running, the running support system comprising:
an execution device; and
a storage device, wherein:
a road where the vehicle runs is stored in the storage device such that the road is divided into a plurality of running areas;
respective reference advancing directions for the running areas are stored in the storage device, the respective reference advancing directions serving as references for an advancing direction of the vehicle when the vehicle runs in the running areas;
the execution device is configured to execute processes including
a specifying process of specifying a currently-running area from among the running areas, the currently-running area being a running area where the vehicle is running,
an appropriate value setting process of setting a vehicle speed appropriate value that is an appropriate vehicle speed when the vehicle runs in the currently-running area, and
a support process of at least either notifying the driver of the vehicle speed appropriate value or decelerating the vehicle in a case where a vehicle speed exceeds the vehicle speed appropriate value; and
in the appropriate value setting process, in a case where the advancing direction of the vehicle does not accord with the reference advancing direction, the execution device sets, as the vehicle speed appropriate value, a value smaller than a value to be set in a case where the advancing direction of the vehicle accords with the reference advancing direction.

2. The running support system according to claim 1, wherein:
in the appropriate value setting process, the execution device determines whether a deviation amount between the advancing direction of the vehicle and the reference advancing direction increases or not, based on at least either one of a lateral acceleration and a yaw rate of the vehicle; and
in a case where the execution device determines that the deviation amount increases, the execution device sets, as the vehicle speed appropriate value, a value smaller than a value to be set in a case where the execution device determines that the deviation amount does not increase.

3. The running support system according to claim 1, wherein:
in the appropriate value setting process, the execution device determines whether a deviation amount between the advancing direction of the vehicle and the reference advancing direction increases or not, based on a steering angle; and
in a case where the execution device determines that the deviation amount increases, the execution device sets, as the vehicle speed appropriate value, a value smaller than a value to be set in a case where the execution device determines that the deviation amount does not increase.

4. The running support system according to claim 1, wherein the processes to be executed by the execution device includes
a road-surface condition acquisition process of acquiring a road-surface condition in the currently-running area, and
a correction process of correcting the vehicle speed appropriate value set in the appropriate value setting process based on the road-surface condition in the currently-running area.

5. The running support system according to claim 1, wherein:
the storage device includes a map in which respective reference vehicle speed appropriate values as references for the vehicle speed appropriate value in respective running areas are stored;
in the appropriate value setting process, the execution device acquires a reference vehicle speed appropriate value corresponding to the currently-running area from the map; and
in a case where the advancing direction of the vehicle accords with the reference advancing direction, the execution device sets, as the vehicle speed appropriate value, a value corresponding to the reference vehicle speed appropriate value thus acquired.

6. The running support system according to claim 5, wherein:
the map included in the storage device includes a plurality of maps such that the maps correspond to respective vehicle types;
in the appropriate value setting process, the execution device selects a map corresponding to a vehicle type of the vehicle from among the maps included in the storage device; and
the execution device acquires the reference vehicle speed appropriate value corresponding to the currently-running area from the map.

7. The running support system according to claim 1, wherein:
the execution device includes a first execution device provided outside the vehicle, and a second execution device provided in the vehicle; and
the second execution device executes some of the processes, and the first execution device executes remaining processes of the processes.

8. A running support method for a vehicle, the running support method being for supporting a vehicle operation performed by a driver during vehicle running, the vehicle running support method comprising:
a specifying process of specifying a currently-running area from among a plurality of running areas set by dividing a road where the vehicle runs, the currently-running area being a running area where the vehicle is running;
an appropriate value setting process of setting a vehicle speed appropriate value that is an appropriate vehicle speed when the vehicle runs in the currently-running area specified by the specifying process; and
a support process of at least either notifying the driver of the vehicle speed appropriate value set in the appropriate value setting process or decelerating the vehicle in a case where a vehicle speed of the vehicle exceeds the vehicle speed appropriate value, wherein:
respective reference advancing directions are set for the running areas, the respective reference advancing directions serving as references for an advancing direction of the vehicle when the vehicle runs in the respective running areas; and
in the appropriate value setting process, in a case where the advancing direction of the vehicle does not accord with the reference advancing direction, a value smaller than a value to be set in a case where the advancing direction of the vehicle accords with the reference advancing direction is set as the vehicle speed appropriate value.
